(19) United States
(12) Patent Application Publication
(10) Pub. No.: US 2008/0235695 A1
(43) Pub. Date: Sep. 25, 2008

(54) RESOURCE ALLOCATION SYSTEM FOR JOBS, RESOURCE ALLOCATION METHOD AND RESOURCE ALLOCATION PROGRAM FOR JOBS

(75) Inventor: Mikio ITOU, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION, Tokyo (JP)

(21) Appl. No.: 12/045,763

(22) Filed: Mar. 11, 2008

(30) Foreign Application Priority Data
Mar. 23, 2007 (JP) 2007-077633

(51) Int. Cl. G06F 9/46

(52) U.S. Cl. 718/103

(57) ABSTRACT

A resource allocation system for jobs includes: a timer for notifying switch of priority jobs in a priority period based on a predetermined processor priority allocation time of each job; a dispatcher for taking out a head process from a ready queue which is a queue of a process corresponding to a job selected as a priority job and being executable by an information processing system, for each job, based on the notification, and for allocating it to an instruction execution unit; and the instruction execution unit for executing an instruction of an executing process which is an allocated process.

### CROSS-REFERENCE TO RELATED APPLICATION

This application is based upon and claims the benefit of priority from Japanese patent application No. 2007-077633, filed on Mar. 23, 2007, the disclosure of which is incorporated herein in its entirety by reference.

### BACKGROUND OF THE INVENTION

1. Field of the Invention

The present invention relates to a resource allocation system for jobs, and in particular, relates to a resource allocation system for jobs, a resource allocation method for jobs and a program, which adjust load balancing when a plurality of jobs are executed by one system.

2. Description of the Related Art

As a resource allocation method for general jobs, there is a scheduling method which guarantees a CPU allocation time to the jobs (For example, Japanese Patent Application Laid-open No. 2000-148512 (Patent Document 1)). In this scheduling method, a CPU allocation guaranteed job is predetermined, and a CPU operating time used for the job is timed. When the CPU more than a certain time is not allocated within a predetermined unit of time, the CPU is allocated to the job by priority. In order to accomplish that, it is determined whether or not the job is a CPU allocation guaranteed job at the beginning of job, and when the job is determined as the CPU allocation guaranteed job, a job management table of the job is registered on a management table of the CPU allocation guaranteed job. Next, it is determined whether or not the job is waiting a shared resource. When the job is determined as waiting the shared resource, it is determined whether or not a job securing the shared resource in first is the CPU allocation guaranteed job. Then, when it is determined that the job is not the CPU allocation guaranteed job, a job management table of the job to which a temporary priority flag is set is registered on a management table of the CPU allocation guaranteed job so as to perform the processing for releasing the shared resource. Meanwhile a CPU allocation guarantee control section started by a timer processing section updates a priority schedule queue referring to a CPU operating time, a CPU allocation guarantee time and a CPU allocation monitoring time from which the job starts. Then, a CPU allocation processing for the job is performed by a scheduler.

However, in this method, in order to schedule jobs and allocate CPU to them, a complicated processing of making a job management table so as to register it on a management table of a CPU allocation guaranteed job have to be performed, as mentioned above. As a result, there have been problems that overhead is large and versatility lacks.

### SUMMARY OF THE INVENTION

It is therefore an exemplary object of the invention to provide a resource allocation system for jobs, a resource allocation method for jobs and a program having a less overhead, a simple configuration and a superior versatility in the case of executing a plurality of jobs by one system.

In order to achieve such an object, a resource allocation system for jobs according to an exemplary aspect of the invention includes: a timer which notifies switch of jobs based on a predetermined processor priority allocation time of each job; an instruction execution unit which executes an instruction of a process; and a dispatcher which takes out a head process from a ready queue including a process which corresponds to a job selected as a priority job based on a notification from the timer, and allocates it to the instruction execution unit so as to execute the instruction of the process.

A resource allocation method for jobs according to another exemplary aspect of the invention is a resource allocation method for jobs in an information processing system. The method includes the steps of: notifying switch of jobs based on a predetermined processor priority allocation time of each job; and taking out a head process from a ready queue including a process which corresponds to a job selected as a priority job based on the notification so as to execute the instruction of the process.

A program according to still another exemplary aspect of the invention causes a computer to execute: functions to notify switch of jobs to an information processing system based on a predetermined processor priority allocation time of each job; and to take out a head process from a ready queue including a process which corresponds to a job selected as a priority job based on the notification so as to execute the instruction of the process.

### BRIEF DESCRIPTION OF THE DRAWINGS

FIG. 1 is a block diagram showing a configuration of a first exemplary embodiment of the invention;

FIG. 2 is a block diagram showing a system configuration of the first and a second exemplary embodiments of the invention;

FIG. 3 is a diagram showing an image of a ready queue group and an executable process group in the first exemplary embodiment of the invention;

FIG. 4 is a diagram showing a structure of a process identification number in the first exemplary embodiment of the invention;

FIG. 5 is an example showing a cycle and a system allocation time in the first exemplary embodiment of the invention;

FIG. 6 is a diagram showing an image of relations among a processor allocation for each job, a dispatcher and a timer in the first exemplary embodiment of the invention;

FIG. 7 is a flowchart showing a basic operation of a resource allocation for jobs in the first exemplary embodiment of the invention;

FIG. 8 is a flowchart showing an operation performed when an executing process belonging to a highest priority job exists on a processor in the first exemplary embodiment of the invention;

FIG. 9 is a flowchart showing an operation performed when an executing process belonging to a highest priority job does not exist on a processor and an executable process exists in a ready queue of the highest priority job in the first exemplary embodiment of the invention;

FIG. 10 is a flowchart showing an operation performed when neither an executing process nor an executable process belonging to a highest priority job exist, and a switch instruction of priority period from a timer exists in the first exemplary embodiment of the invention;

FIG. 11 is a flowchart showing an operation performed when neither an executing process nor an executable process belonging to a highest priority job exist, no switch instruction of priority period from a timer and no executing process belonging to jobs A to F on a processor exists in the first exemplary embodiment of the invention; and

FIG. 12 is a block diagram showing a configuration of the second exemplary embodiment of the invention.

### DESCRIPTION OF EXEMPLARY EMBODIMENTS

Next, exemplary embodiments of the invention will be explained with reference to the drawings.

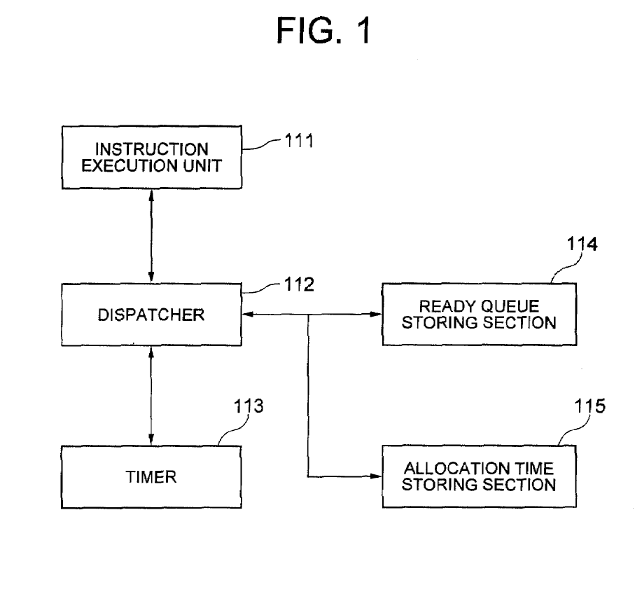

Referring to FIG. 1, the first exemplary embodiment of the invention includes an instruction execution unit 111, a dispatcher 112, a timer 113, a ready queue storing section 114, and an allocation time storing section 115.

The instruction execution unit 111 executes an instruction configuring an executable process selected by the dispatcher 112.

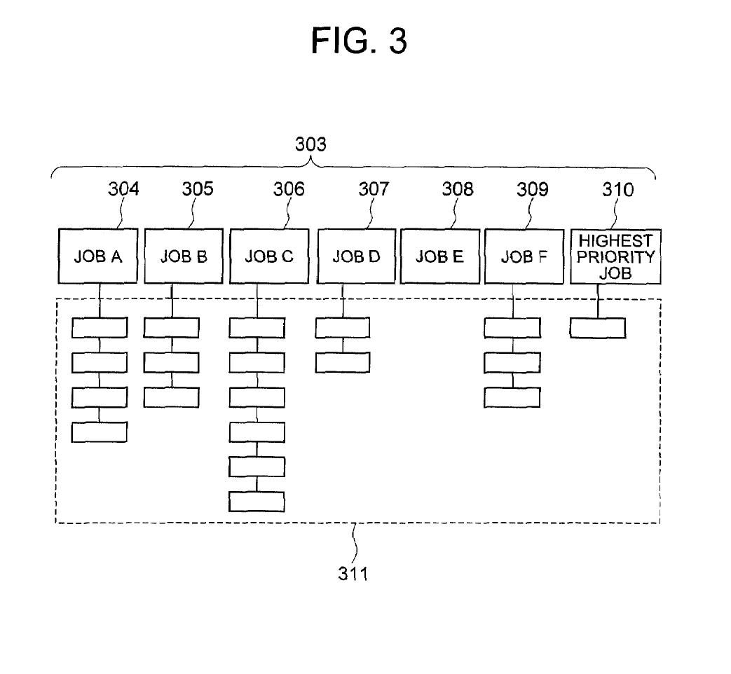

The dispatcher 112 selects one executable process to execute its instruction from an executable process group 311 shown in FIG. 3. The dispatcher 112 sends an allocation time of priority period of job to the timer 113. The dispatcher 112 switches the job in the priority period when it receives a switch instruction from the timer 113.

When the timer 113 receives the allocation time that the dispatcher 112 sends, it times the priority period of the job. When the priority period reaches the allocation time, the timer 113 outputs the switch instruction to the dispatcher 112.

The ready queue storing section 114 stores a ready queue group in which an executable process for each job is made to be a queue.

Referring to FIG. 3, the ready queue group 303 includes ready queues 304 to 309 and a ready queue 310. The ready queues 304 to 309 correspond to jobs A to F respectively, and configure queues of executable processes being under the corresponding jobs A to F in the executable process group 311. For example, a ready queue 306 configures queue of executable process being under job C.

The ready queue 310 corresponds to a highest priority job and configures a queue of executable exception process being under the highest priority job. When, a system common processing which does not correspond to jobs A to F, or a process which corresponds to jobs A to F but needs urgency, is defined as an exception process, the highest priority job indicates set of exception process.

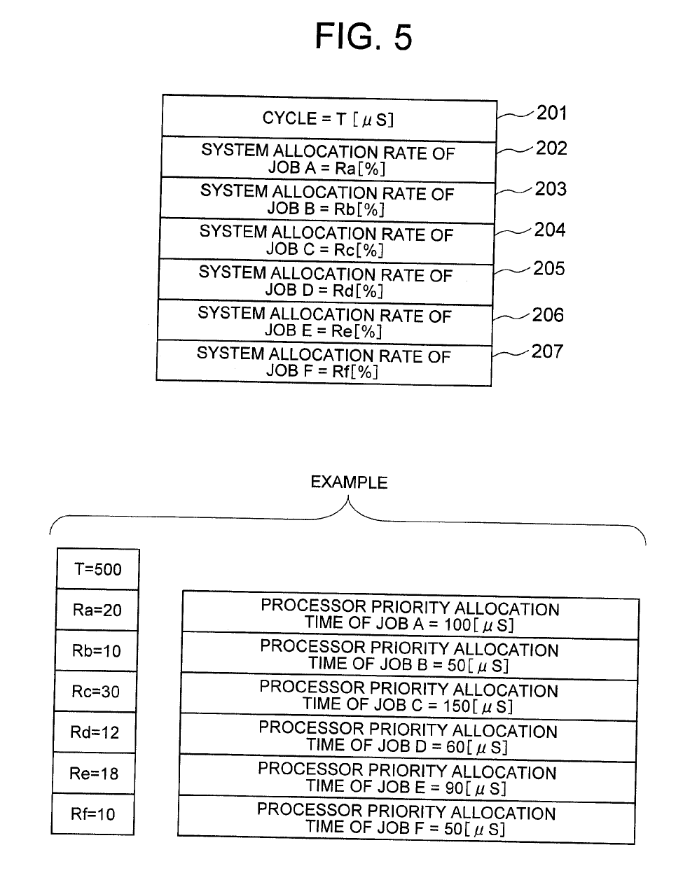

When the executable process is placed at the ready queue 310, the dispatcher 112 selects the executable process placed at the head thereof by highest priority. The instruction execution unit 111 executes the instruction of the selected executable process. In the highest priority job, as nothing corresponding to allocation rates 202 to 207 for jobs A to F (see FIG. 5) is defined, the highest priority job does not have equivalent to a processor priority allocation time.

The executable process group 311 is selected by the dispatcher 112 and is a process group waiting to be executed by the instruction execution unit 111.

Generally, since it is well known technique to those skilled in the art that processes are placed at a ready queue to configure a queue and are taken from the ready queue so as to be executed, useful points for understanding the exemplary embodiment easily will be explained. In the exemplary embodiment, a process in an execution state which is performed by the instruction execution unit 111 is defined as an executing process. There is only one executing process at any point. A process has own priority order relating to an execution sequence in jobs A to F or in the highest priority job.

The ready queues 304 to 309 and the ready queue 310 configure queues of executable processes in order of the priority by first-in first-out method, for each ready queue. A higher priority process is connected to the head side of the corresponding ready queue compared to a lower priority process. In the case of processes having equal priority, a process which is placed temporally in first is placed at the head side of the corresponding ready queue.

Therefore, the executable processes placed at the head of the ready queues 304 to 309 and the ready queue 310 have the highest priority in the executable processes configuring the ready queues 304 to 309 and the ready queue 310, and they could be in the execution state, or executing processes, performed by the instruction execution unit 111.

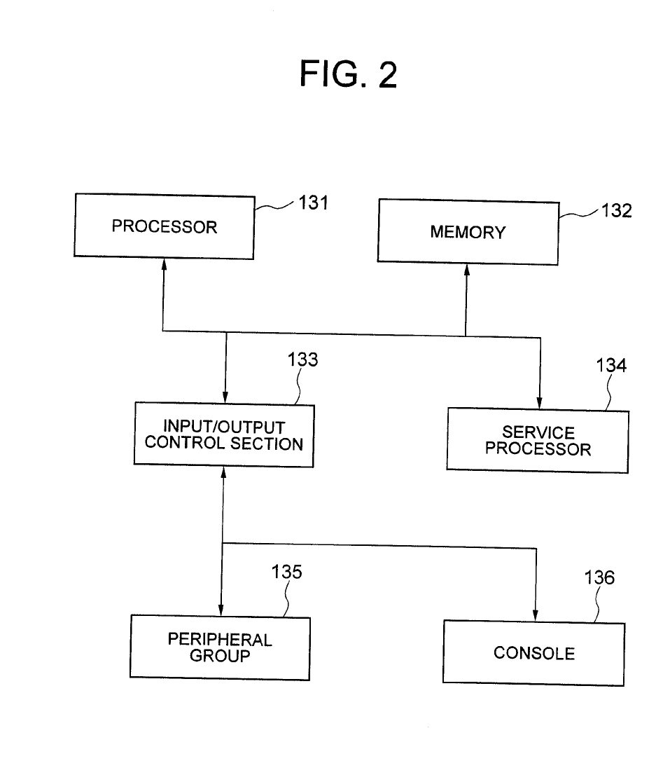

FIG. 2 shows an example of the system configuration with which this exemplary embodiment is operated. The exemplary embodiment includes a processor 131, a memory 132, an input/output control section 133, a service processor 134, a peripheral group 135 and a console 136.

In this exemplary embodiment, the processor 131 executes calculations and other data processing in order of program. The instruction execution unit 111, the dispatcher 112 and the timer 113 are realized by the corresponding programs respectively and the processor 131.

In this exemplary embodiment, the memory 132 stores a program, and work area, buffer and the like of the program. The memory 132 includes at least the ready queue storing section 114 and an allocation time storing section 115.

The input/output control section 133, the service processor 134, the peripheral group 135 and the console 136 are well known techniques configuring a general computer system, as they are not in special place in the exemplary embodiment, the description thereof are omitted.

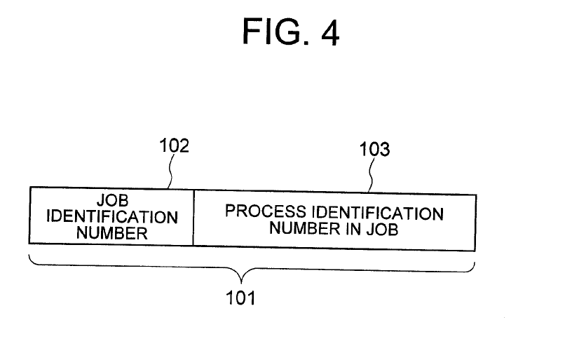

FIG. 4 is a diagram showing a structure of process identification number 101 in the system to which the exemplary embodiment is adapted. A job identification number 102 is a unique number corresponding to each job within the system. A process identification number 103 in the job is a unique number corresponding to each process in the job. The process identification number 101 in the system is a number combining the job identification number 102 and the process identification number 103 in the job, and is a unique number corresponding to each process in the system. Each job and each process executed in the system to which the exemplary embodiment is adapted is identified, managed and controlled by the process identification number 101 in the system, the job identification number 102 and the process identification number 103 in the job.

Next, the operation of the first exemplary embodiment of the invention will be explained with reference to FIG. 1 to FIG. 11, by indicating specific examples.

FIG. 5 indicates an example of a cycle 201 being a basis for calculating a processor priority allocation time and system allocation rates 202 to 207 in the system to which the exemplary embodiment is adapted. The cycle 201 is a cycle having a certain time period with which a system allocation is repeated. The system allocation rates 202 to 207 correspond to jobs A to F respectively and indicate the system allocation rates for each job in the cycle 201. For example, assuming that a cycle is 500 μs, and system allocation rate 202 for job A is 20%, then the processor priority allocation time being a priority period of job A is 500 μs×0.2=100 μs.

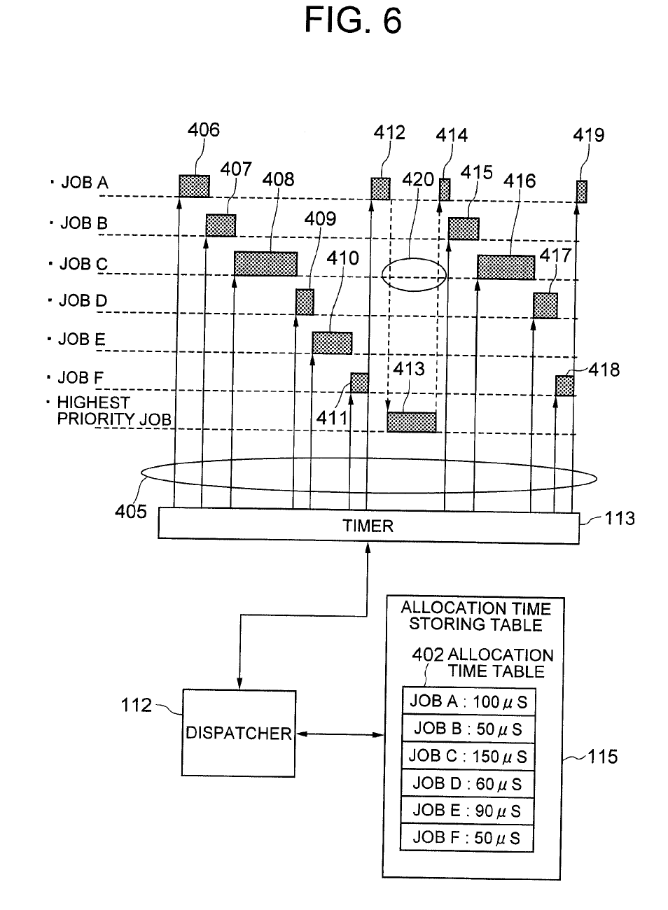

FIG. 6 is an image showing relations among allocation of the instruction execution unit 111 for each job, the dispatcher 112 and the timer 113 in the system to which the exemplary embodiment is adapted.

The dispatcher 112 refers to an allocation time table 402 of an allocation time storing section 115 based on a job identification number 102 so as to obtain an allocation time corresponding to the job identification number 102. Then, the dispatcher 112 outputs the obtained allocation time to the timer 113.

The timer 113 obtains the allocation time that the dispatcher 112 sent so as to begin to time the priority period of the job corresponding to the job identification number 102. When the priority period being timed reaches the allocation time, the timer 113 outputs a switch instruction 405 of priority job to the dispatcher 112. The dispatcher 112 switches the priority job when the switch instruction 405 is obtained. That is, the switch instruction 405 is a switch instruction of executable process which is to be executed by the instruction execution unit 111.

Execution periods 406 to 419 indicate that the corresponding jobs are in the priority period and the instruction execution unit 111 is allocated thereto. In the execution periods 406 to 411, the instruction execution unit 111 is allocated corresponding to the allocation time of jobs A to F. As an execution period 413 of a highest priority job exists between execution periods 412 and 414 of job A, it indicates the state that the executable process is connected to a ready queue 310 of the highest priority job in the execution period 412, and the instruction execution unit 111 is allocated to the head executable process by highest priority. When the executable process connected to the ready queue 310 disappears (the ready queue 310 becomes empty), the continuation of the suspended execution period 412 of job A becomes an execution period 414. In the execution periods 414 to 417, the instruction execution unit 111 is allocated corresponding to the allocation time of jobs A to D. Although an execution period of job E does not exist between execution periods 417 and 418, it indicates that a ready queue 308 of job E is empty at this point. When an execution period 418 of job F terminates, the next is an execution period 419 of job A.

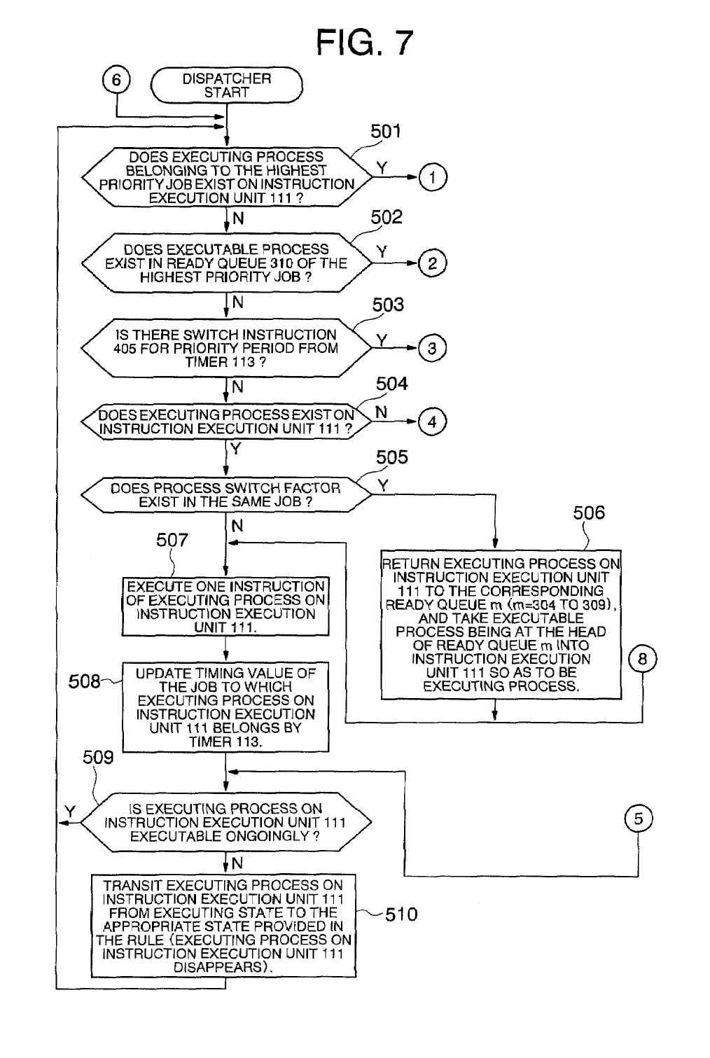

FIG. 7 is a flowchart showing a basic operation of a resource allocation for job in the system to which the exemplary embodiment of the present invention is adapted.

In the following description, the instruction execution unit 111 has the states in which the executing process being in the execution state which is performed by the instruction execution unit 111 does not exist on the instruction execution unit 111 (empty state), and the state in which the executing process is taken on the instruction execution unit 111 and exists on the instruction execution unit 111 (process state). In the process state, one executing process existing on the instruction execution unit 111 is executed. As the executing process taken on the instruction execution unit 111, the executable process having the highest priority at that time is selected by the dispatcher 112 from an executable process group 311 placed at a ready queue group 303.

In the following description, a ready queue m and a ready queue n indicate any one of ready queues 304 to 309.

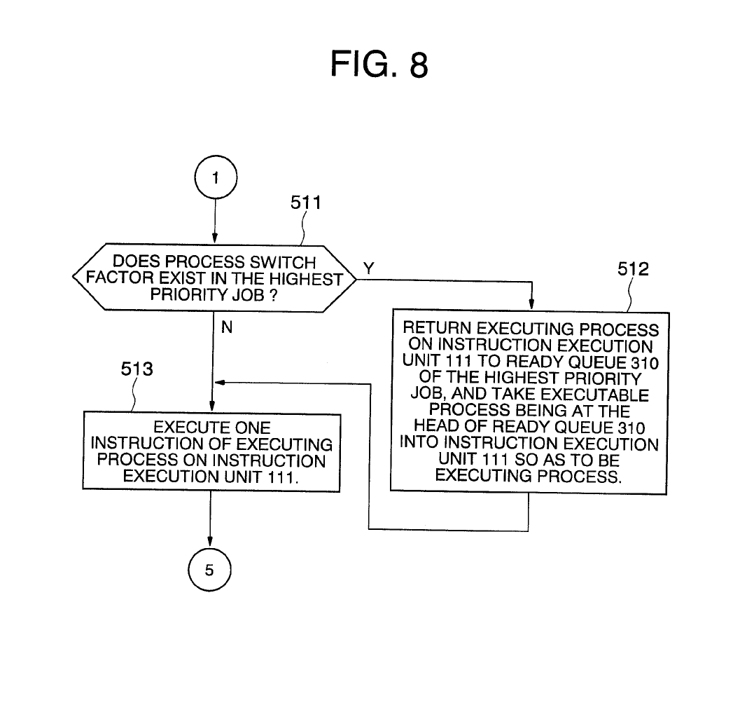

The dispatcher 112 determines whether or not the executing process belonging to the highest priority job exists on the instruction execution unit 111. If it exists, the processing branches and advances to step 511 in FIG. 8. If it does not exist, the processing advances to step 502 (step 501).

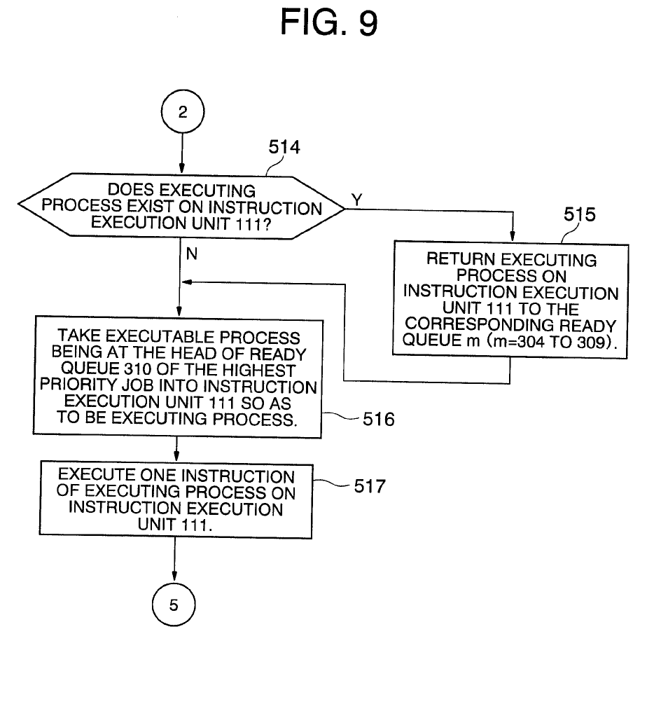

The dispatcher 112 determines whether or not the executable process exists in a ready queue 310 of the highest priority job. If it exists, the processing branches to step 514 in FIG. 9, if it does not exist, the processing advances to step 503 (step 502).

The dispatcher 112 determines whether or not the switch instruction 405 of the priority job from the timer 113 exists. The dispatcher 112 branches the processing to step 518 if the switch instruction 405 of the priority job exists, and advances the processing to step 504 if it does not exist (step 503).

The dispatcher 112 determines whether or not the executing process on the instruction execution unit 111 exists. The dispatcher 112 advances the processing to step 505 if the executing process exists, and advances the processing to step 523 if it does not exist (step 504).

The dispatcher 112 determines whether or not a process switch factor exists in the same job. The dispatcher 112 advances the processing to step 506 if the process switch factor exists, and advances the processing to step 507 if it does not exist (step 505). Here, the process switch means the processing of returning the executing process on the instruction execution unit 111 to the executable process group 311 and selecting one executable process from the executable process group 311 in accordance with the rule so as to be the executing process on the instruction execution unit 111.

The dispatcher 112 returns the executing process on the instruction execution unit 111 to the corresponding ready queue m so as to be the executable process, and takes the executable process being at the head of the ready queue m onto the instruction execution unit 111 so as to be the executing process. Thereby, the process switch is performed in the same job, and the processing advances to step 507 (step 506).

The instruction execution unit 111 executes one instruction of the executing process on the instruction execution unit 111. This instruction is one of an instruction group configuring processes, and is the instruction selected from the instruction group in accordance with the predetermined rule. Then, the processing advances to step 508 (step 507).

The timer 113 updates the timing value of job to which the executing process on the instruction execution unit 111 belongs, and times the allocation time given to the job. Then, the processing advances to step 509 (step 508).

The dispatcher 112 determines whether or not the executing process on the instruction execution unit 111 is executable ongoingly. It is due to the rule that, depending on the execution result of the instruction in step 507, the executing process transits from the ready state to another state. The processing branches and advances to step 501 if the executing process is executable ongoingly, and advances to step 510 if it does not (step 509).

The dispatcher 112 transits the executing process on the instruction execution unit 111 from the execution state to the appropriate state provided in the rule. Thereby no executing process exists on the instruction execution unit 111. After that, the processing branches and advances to step 501 (step 510).

FIG. 8 is a flowchart showing an operation in the case where the executing process belonging to the highest priority job exists on the instruction execution unit 111. The dispatcher 112 determines whether or not the process switch factor exists in the highest priority job. If the factor exists, the processing advances to step 512, and if it does not exist, the processing advances to step 513 (step 511).

The dispatcher 112 returns the executing process on the instruction execution unit 111 to the ready queue 310 of the highest priority job so as to be the executable process, and takes the executable process being at the head of the ready queue 310, onto the instruction execution unit 111 so as to be the executing process (step 512).

The dispatcher 112 executes one instruction of the executing process on the instruction execution unit 111. The executing process in the present step 513 belongs to the highest priority job. After that, the processing advances to step 509. Since the highest priority job has nothing corresponding to the processor priority allocation time, step 508 is not executed (step 513).

FIG. 9 is a flowchart showing an operation in the case where the executing process belonging to the highest priority job does not exist on the instruction execution unit 111, and the executable process exists in the ready queue 310 of the highest priority job. The dispatcher 112 determines whether or not the executing process belonging to jobs A to F exists on the instruction execution unit 111. If it exists, the processing advances to step 515, if it does not, the processing advances to step 516 (step 514).

The dispatcher 112 returns the executing process belonging to jobs A to F on the instruction execution unit 111 to the corresponding ready queue m so as to be the executable process. Then, the processing advances to step 516 (step 515).

The dispatcher 112 takes the executable process being at the head of the ready queue 310 of the highest priority job on the instruction execution unit 111 so as to be the executing process (step 516).

The dispatcher 112 executes one instruction of the executing process taken in step 516. Then, the processing branches and advances to step 509. As the highest priority job does not have something corresponding to the processor priority allocation time, step 508 is not executed (step 517).

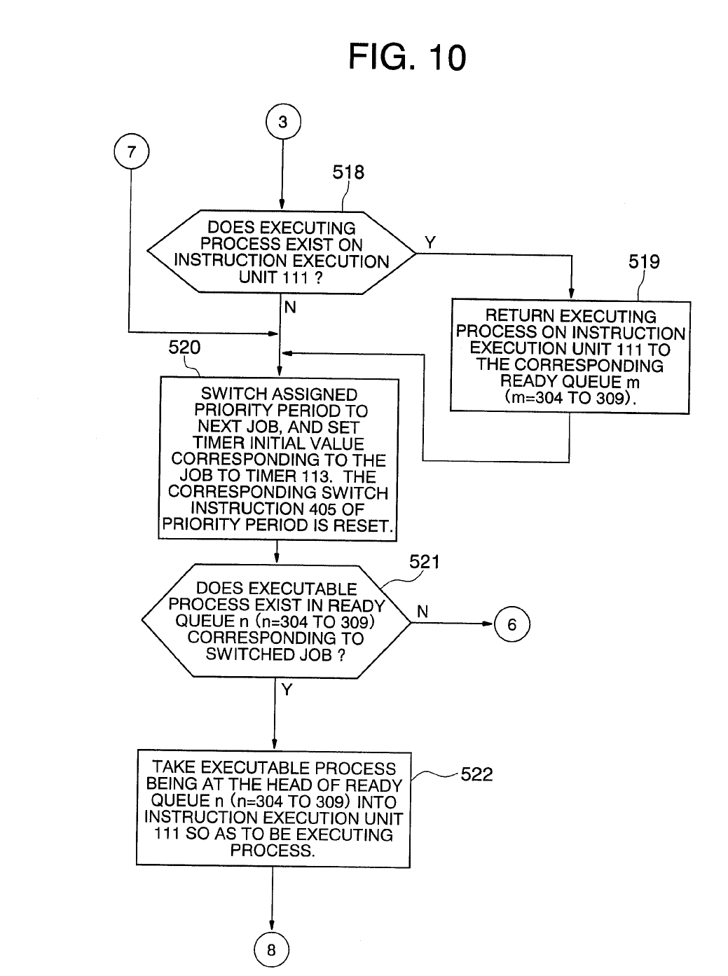

FIG. 10 is a flowchart showing an operation in the case where neither the executing process nor the executable process belonging to the highest priority job exists, and the switch instruction 405 of the priority period from the timer 113 exists. The dispatcher 112 determines whether or not the executing process exists on the instruction execution unit 111. This executing process belongs to any one of jobs A to F. The processing advances to step 519 if the executing process exists on the instruction execution unit 111, and advances to step 520 if it does not (step 518).

The dispatcher 112 returns the executing process on the instruction execution unit 111 to the corresponding ready queue m. This executing process belongs to the job that its priority period terminated. After that, the processing advances to step 520 (step 519).

The dispatcher 112 switches the priority period to be assigned to next job and outputs the allocation time corresponding to the job to the timer 113. The corresponding switch instruction 405 of the priority job in the priority period is reset. Then, the processing advances to step 521 (step 520).

The dispatcher 112 determines whether or not the executable process in the ready queue n (n=304 to 309) which corresponds to the job to which the priority period is switched to be assigned exists. If it exists, the processing advances to step 522, if it does not, the processing branches to step 501 (step 521).

The dispatcher 112 takes the executable process being at the head of the ready queue n onto the instruction execution unit 111 so as to be the executing process. Then, the processing branches to step 507 (step 522).

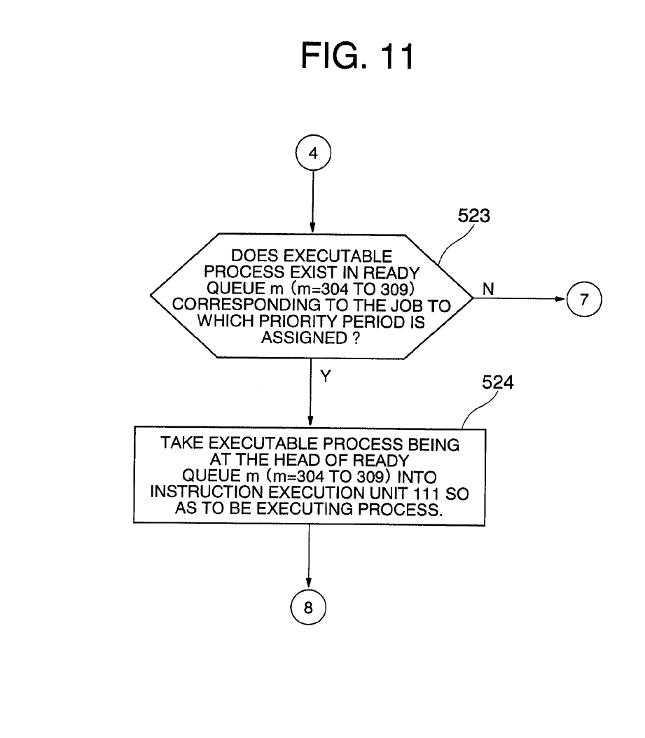

FIG. 11 is a flowchart showing an operation in the case where neither executing process nor executable process belonging to the highest priority job exists, no switch instruction 405 of the priority period from the timer 113 and no executing process belonging to jobs A to F on the instruction execution unit 111 exists. The dispatcher 112 determines whether or not the executable process exists in the ready queue m corresponding to the priority period assigned job. If it exists, the processing advances to step 524, if it does not, the processing branches and advances to step 520 so that the priority period is switched and assigned to next job (step 523).

The dispatcher 112 takes the executable process being at the head of the ready queue m, which corresponds to the assigned job for the priority period, onto the instruction execution unit 111 so as to be the executing process. Then, the processing branches and advances to step 507 (step 524).

In this way, according to the rule as described above, the dispatcher 112 takes the process belonging to the job from the head of the ready queue corresponding to the job within the priority allocation time of a specific job, so as to be the executing process on the instruction execution unit 111.

As an exemplary advantage according to the invention, in the case where a plurality of jobs are executed by one system, even when load balancing of a specific job becomes large, it is possible to present a resource allocation system for jobs which is capable of preventing the situation in which performance of another job degrades or another job is not executed from occurring, and which has less overhead, a simple configuration and a superior versatility. The reason is, switching a priority period for job is notified based on a predetermined processor priority allocation time of each job, and based on the notification, a process of a job selected as a job which is executed in the priority period is taken out from a head of the ready queue which is a queue of processes executable by a processor, and the process is allocated to processor so as to be executed.

According to the first exemplary embodiment of the invention, the processor allocation time based on the predetermined system allocation rate for each job is defined as the priority period of each job. The executable process which belongs to each job is placed at the ready queue corresponding to each job, and the executable process which is placed at the head of the ready queue corresponding to each job is selected within the priority period of each job so as to be allocated to the processor and executed. Thereby, the processor allocation time of each job becomes almost the same as the predetermined system allocation rate for each job, and in the case where a plurality of jobs are executed by one system, it is possible to prevent the situation that another job is not executed or the system allocation rate decreases from occurring when load of a specific job becomes large.

Further, according to the first exemplary embodiment of the invention, even if a specific job is in the priority job period in the case of where task to be executed is empty and the ready queue of the priority job is empty, another job is switched to be priority job. Thereby it is possible to lighten load balancing of a specific job, and in the case where the system operating time of the job does not reach the predetermined system allocation rate, to allocate the system to another job without wasting the system operating time.

Further, according to the first exemplary embodiment of the invention, the job, which needs a system common processing or urgency, is defined as the highest priority job, and a ready queue corresponding to the highest priority job is included. In the case where the executable process is connected to the ready queue, that is, in the case where a job to be executed in the highest priority task occurs, the system is allocated thereto by highest priority. Thereby, for the highest priority job, it is possible to allocate the system thereto by highest priority regardless whether or not another job is the priority job.

Next, the second exemplary embodiment of the invention will be explained in detail with reference to the drawings.

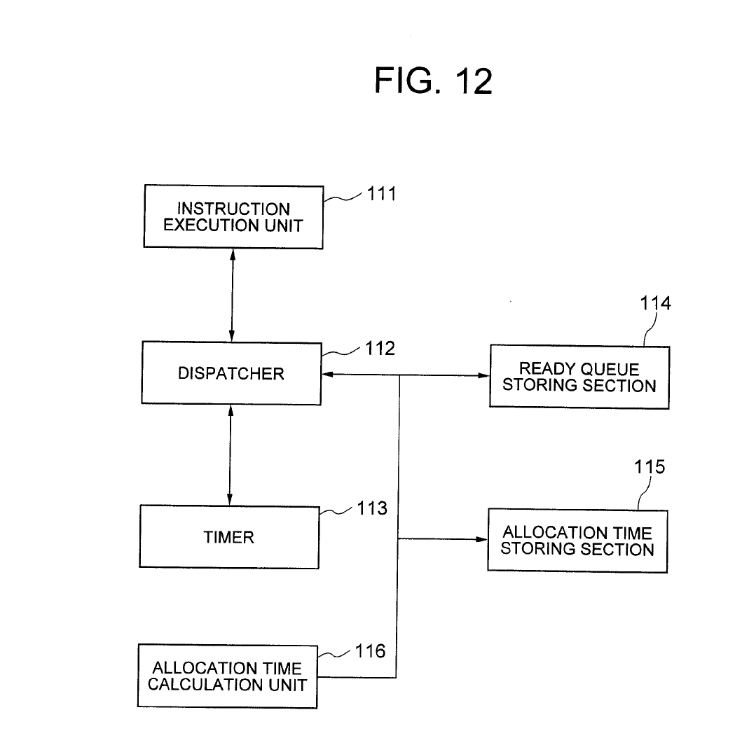

FIG. 12 is a block diagram showing a configuration of the second exemplary embodiment of the invention. The second exemplary embodiment of the invention differs from the first exemplary embodiment of the invention in that an allocation time calculation unit 116 is added compared to FIG. 1, which is a block diagram showing a configuration of the first exemplary embodiment of the invention.

The allocation time calculation unit 116 obtains a cycle 201 and system allocation rates 202 to 207 for each job shown in FIG. 5, which are input from a service processor 134 or a console 136 shown in FIG. 2, for example. Then, the allocation time calculation unit 116 calculates a processor priority allocation time of each job based on the cycle 201 and the system allocation rates 202 to 207 for each job shown in FIG. 5 so as to store them in an allocation time table 402 shown in FIG. 6.

With respect to an operation of the second exemplary embodiment, the specific example will be explained in detail with an example shown in FIG. 5. The allocation time calculation unit 116 obtains, by some kind of measure not shown in figure, “500” as the cycle 201=T[μs], “20” as a system allocation rate 202 for job A=Ra[%], “10” as a system allocation rate 203 for job B=Rb[%], “30” as a system allocation rate 204 for job C=Rc[%], “12” as a system allocation rate 205 for job D=Rd[%], “18” as a system allocation rate 206 for job E=Re[%], and “10” as a system allocation rate 207 for job F=Rf[%] shown in FIG. 5. Based on that, the allocation time calculation unit 116 calculates the processor priority allocation time of job A=500[μs]×0.2=100[μs], the processor priority allocation time of job B=500[μs]×0.1=50[μs], the processor priority allocation time of job C=500[μs]×0.3=150[μs], the processor priority allocation time of job D=500[μs]×0.12=60[μs], the processor priority allocation time of job E=500[μs]×0.18=90[μs], and the processor priority allocation time of job F=500[μs]×0.1=50[μs]. Then, the allocation time calculation unit 116 stores them the allocation time table 402 shown in FIG. 6.

Further, the allocation time calculation unit 116 recalculates the processor priority allocation time in the case of termination of job or addition of job.

Hereinafter, an operation for recalculating the processor priority allocation time in the case where job G is added to the condition shown in FIG. 5 will be explained in detail. The dispatcher 112 instructs the allocation time calculation unit 116 to recalculate the processor priority allocation time when the dispatcher 112 detects the addition of job. The allocation time calculation unit 116 obtains the system allocation rate for job G, Rg [%]=“10”. The cycle 201=“500[μs]” shown in FIG. 5 is divided in such a way that total of the system allocation rates for jobs A to F come to “100%”. Therefore, the allocation time calculation unit 116 combines the system allocation rate for job G so as to recalculate the system allocation rates for jobs A to F so that the total comes to be 100%. The allocation time calculation unit 116 calculates the system allocation rate 202 for job A=Ra[%]=20[%]÷1.1=18[%], the system allocation rate 203 for job B=Rb[%]=10[%]÷1.1=9[%], and as well as from job C to the followings, the system allocation rate for job G, Rg[%]=10[%]÷1.1=9[%].

Then, the allocation time calculation unit 116 recalculates the processor priority allocation time of each job based on the recalculated system allocation rate for each job.

Meanwhile, in the above example, it is explained the case that the system allocation rate is recalculated without changing the cycle. Instead of the cycle 201=“500 [μs]”, it may be calculated as the cycle 201=“550 [μs]” by adding the processor priority allocation time “50[μs]”, which corresponds to the system allocation rate for job G, Rg[%]=“10”, to the cycle.

Further, when a job terminates, the same method can be adapted thereto easily.

According to the second exemplary embodiment of the invention, based on the cycle of allocation and the system allocation rate for each job, and corresponding to termination or addition of jobs, the processor priority allocation time is calculated. Thereby, it is possible to provide the resource allocation system for jobs, which can save calculating the processor priority allocation time in advance and is versatile.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

### INDUSTRIAL APPLICABILITY

The present invention is useful in a general information processing device, especially in the case where a plurality of functions is processed on one processor.

As the applicable example of the present invention, in case where an input/output processing such as network, disk, tape and console is performed on one processor, it is possible for each processing to use the processor effectively with the predetermined rate.

What is claimed is:

1. A resource allocation system for jobs comprising:
a timer which notifies switch of jobs based on a predetermined processor priority allocation time of each job;
an instruction execution unit which executes an instruction of a process; and
a dispatcher which takes out a head process from a ready queue including a process which corresponds to a job selected as a priority job based on a notification from the timer, and allocates it to the instruction execution unit so as to execute the instruction of the process.

2. The resource allocation system for jobs, as claimed in claim 1, wherein the dispatcher selects a next priority job, when the ready queue of the job selected as the priority job is empty.

3. The resource allocation system for jobs, as claimed in claim 2, wherein the processor priority allocation time is a time that a cycle having a certain period is divided by a system allocation rate for each job.

4. The resource allocation system for jobs, as claimed in claim 1, wherein the dispatcher gives priority to a highest priority job corresponding to an exception process rather than the priority job, takes out the exception process being at the head of an exception ready queue, and allocates it to the instruction execution unit so as to execute the instruction of the exception process, when the exception process exists in the exception ready queue including the exception process to execute a predetermined processing.

5. The resource allocation system for jobs, as claimed in claim 1, wherein the dispatcher returns an executing process to the corresponding ready queue, takes out a process being at the head of the ready queue, and allocates it to the instruction execution unit so as to execute the instruction of the process, when priorities change among processes corresponding to the priority job.

6. The resource allocation system for jobs, as claimed in claim 5, wherein the dispatcher returns an exception executing process to the corresponding exception ready queue, takes out an exception process being at the head of the exception ready queue, and allocates it to the instruction execution unit so as to execute the instruction of the exception process, when priorities change among exception processes corresponding to the highest priority job.

7. The resource allocation system for jobs, as claimed in claim 1, wherein the timer updates a timing value of a priority period of a job corresponding to an executing process so as to determine whether it reaches the processor priority allocation time of the job, whenever the instruction execution unit executes one instruction of a process.

8. The resource allocation system for jobs, as claimed in claim 1, comprising a unit for recalculating the processor priority allocation time corresponding to occurrence of a termination and an addition of the job.

9. A resource allocation system for jobs comprising:
a timer for notifying switch of jobs based on a predetermined processor priority allocation time of each job;
an instruction execution means for executing an instruction of a process; and
a dispatcher for taking out a head process from a ready queue including a process which corresponds to a job selected as a priority job based on a notification from the timer, and allocating it to the instruction execution means so as to execute the instruction of the process.

10. A resource allocation method for jobs in an information processing system, comprising:
notifying switch of jobs based on a predetermined processor priority allocation time of each job;
taking out a head process from a ready queue including a process which corresponds to a job selected as a priority job based on the notification; and
executing the instruction of the process.

11. The resource allocation method for jobs, as claimed in claim 10, further comprising: when the ready queue of a job selected as a priority job based on the notification is empty, selecting a next priority job.

12. The resource allocation method for jobs, as claimed in claim 10, wherein the processor priority allocation time is a time that a cycle having given period is divided by a system allocation rate for the each job.

13. The resource allocation method for jobs, as claimed in claim 10, further comprising: when an exception process exists in an exception ready queue including the exception process to execute a predetermined processing, giving priority to a highest priority job corresponding to an exception process rather than the priority job; taking out the exception process being at the head of the exception ready queue; and executing the instruction of the exception process.

14. The resource allocation method for jobs, as claimed in claim 10, further comprising: when priorities change among processes corresponding to the priority job, returning an executing process to the corresponding ready queue; taking out a process being at the head of the ready queue; and executing the instruction of the process.

15. The resource allocation method for jobs, as claimed in claim 10, further comprising: when priorities change among exception processes corresponding to the highest priority job, returning an exception executing process to the corresponding exception ready queue; taking out an exception process being at the head of the exception ready queue; and executing the instruction of the exception process.

16. The resource allocation method for jobs, as claimed in claim 10, further comprising: whenever one instruction of the process is executed, updating a timing value of a priority period of a job corresponding to an executing process; and determining whether it reaches the processor priority allocation time of the job.

17. The resource allocation method for jobs, as claimed in claim 10, comprising: recalculating the processor priority allocation time corresponding to occurrences of a termination or an addition of the job.

18. A program for causing a computer to execute: functions to notify switch of jobs to an information processing system based on a predetermined processor priority allocation time of each job; and to take out a head process from a ready queue including a process which corresponds to a job selected as a priority job based on the notification so as to execute the instruction of the process.
